(19) United States
(12) Patent Application Publication
(10) Pub. No.: US 2015/0193748 A1
(43) Pub. Date: Jul. 9, 2015

(54) Method for Electronic Transfer of Money

(71) Applicant: Randolph M Pentel, Mendota Heights, MN (US)

(72) Inventor: Randolph M Pentel, Mendota Heights, MN (US)

(21) Appl. No.: 14/594,077

(22) Filed: Jan. 9, 2015

Related U.S. Application Data
(60) Provisional application No. 61/925,226, filed on Jan. 9, 2014.

(51) Int. Cl. G06Q 20/10; G06Q 20/02; G06Q 20/32

(52) U.S. Cl. CPC G06Q 20/10; G06Q 20/322; G06Q 20/02

(57) ABSTRACT

A payment method for electronic transfers of money is disclosed wherein a payment facilitator is employed to identify payer and payee and provide instructions on payer's behalf to transfer funds from payer's account to payee's account. Either or both payer and payee may be members of the payment facilitator system so that their information is available to direct electronic transfer of funds in real-time from payer to payee. A third party member may act as agent for a non member payer or payee, thereby making it an open or closed loop system. Payment facilitator has security information of payer such as photographs and or bio-identifiers or information like answers to security questions, random number codes, or identifying images to secure access to payer's accounts. Payee is notified in real-time by payment facilitator if payment has been made so that goods or services may be released to payer.

### BACKGROUND OF THE INVENTION

1. Field of the Invention

This invention relates to a payer initiated method for securely transferring funds between accounts at financial institutions or non financial institutions or organizations which hold funds on behalf of another to provide instant withdrawals from the payer and instant deposits to the payee by means of a payment facilitator for a fixed fee per transaction.

2. Description of the Related Art

Credit cards typically extend credit to the card holder who then pays the credit card company within a specified time period after the credit is extended. If the payment to the credit card company is not paid in full at the due date interest and fees may be charged to the credit card holder. In addition the credit card company charges the merchant an interchange fee of a % of each transaction and may also charge a transaction fee per transaction. In addition the merchant is not paid immediately by the credit card company. The merchant may wait days before receiving his money. The benefit of accepting the credit card for payment is that once the credit card company approves the payment the risk of credit card fraud passes to the credit card company to protect the merchant and the credit card holder. Credit card fraud is a huge problem as lost or stolen cards are used by criminals. A person wishing to have a credit card must apply for it and be accepted based on his creditworthiness and may have to pay an annual fee for the issuance of the credit card.

Debit cards are similar to credit cards in that the fees charged to the merchant per use are similar. The difference is that no credit is extended. Money is transferred from the debit card holder's account to the merchant's account, but the transfer may not be immediate and the risk of fraud is still present. Applying for a debit card is usually tied to an account at a bank or other financial institution and money is withdrawn from that account as transactions occur.

PayPal® offers a debit in real-time because all money held is “pooled” in a single large account, but the payee does not receive the actual cash for several days plus there is a 3% interchange fee and a transaction fee of 30 cents per transaction.

Electronic checks can take several days for the actual cash to be deposited in the payee's account.

With transactions using Automated Clearing House (ACH) through the Federal Reserve payees may not be paid for several days. Similarly there are private clearing houses used in place of the Federal Reserve, but again the payees may not be paid for several days.

There are many identification systems to prevent fraud including pin numbers and methods for biometric identification associated with credit cards and debit cards.

There are intermediary services such as PayPal® which offer additional protections and services with large fees attached and do not pay the payee directly in real-time.

Even cash has a risk of loss through accepting counterfeit notes.

Some services for transfers of money use pooled money in one account, which may put the money at risk for both the payer and the payee as the pooled money is not in a federally or otherwise insured account and may be subject to risks if there are not sufficient funds to pay the payees; additionally they are not eligible for federal insurance.

Some electronic payment systems use electronic wallets to store customer credit card or debit card information as a substitute for presenting an actual card.

In all the above payment systems the merchant looks to the credit card company or the debit card company for payment after the authorization for payment has been approved and then waiting for the payment to occur. The merchant is at risk for clawbacks from the credit card company or the debit card company if the payment is challenged by the card holder.

### SUMMARY OF THE INVENTION

A transaction facilitator service is offered for providing real-time transfer of money from a member or non member payer to a member or non member payee. This would be considered an open or closed loop system. The transaction facilitator payment system offers payer identity safeguards to prevent fraud and provides the payee a low cost real-time transfer of funds. The payer initiates the payment process by electronically contacting the payment facilitator either on his own or through the merchant's computerized electronic payment system. As payer directs payment to be made the transaction facilitator may notify both the customer (payer) and the merchant (payee) if there are sufficient funds in the customer's (payer's) bank account and, if so, issues instructions to electronically transfer the funds to the merchant's (payee's) bank account in real-time so the merchant is paid before releasing the goods or providing services. If there are insufficient funds, a message so stating is returned to payer or both payer and payee and the transaction is terminated or the payer may have the option of selecting another payer account to complete the transaction. The transaction facilitator charges a small per transaction fee, such as a nickel, which may be paid by either payer or payee, This saves payees interchange fees which are typically a percentage of each transaction, as well as a fee per transaction which credit and debit cards often charge. The payer has an account with the transaction facilitator with his identity information and the information about the bank or other financial institution, or other third party organization the payer has accounts with. The merchant uses the identity information to confirm the transaction is being authorized by the real or correct transaction facilitator member. The transaction facilitator issues instructions for the transfer of funds between the accounts of the customer and the merchant.

The payment facilitator system may also have user protections in the form(s) of anti-fraud feature(s) to protect the user from identity theft or other possible forms of abuse of the account. The protection may extend to protecting not only the identity of the proper owner of the account (payer) but also the payee side as well. This protection may also take the form of financial compensation or guarantee for protection from abuse of the account if it is proven to be outside of the owner's knowledge or control. Violations such as merchant and consumer data breaches would no longer be possible at the retailer levels since the merchant will not be responsible for maintaining any confidential or financial payment data; that will be the responsibility of the payment facilitator.

### OBJECTS OF THE INVENTION

It is an object of the invention to provide secure transactions to prevent fraud.

It is an object of the invention to provide instant withdrawals from the payer and instant deposits to the payee.

It is an object of the invention to eliminate percent of sales charges in transactions

It is an object of the invention to reduce transaction fees.

It is an object of the invention to promote user loyalty to participating retailers.

It is an object of the invention to increase customer traffic in participating establishments.

It is an object of the invention to provide quick and easy transfers of payments without having credit cards or debit cards.

It is an object of the invention to provide a real-time payment network.

It is an object of the invention to eliminate provisional credit delays in transactions.

It is an object of the invention to prevent stolen identity and card theft or fraud.

It is an object of the invention to provide a transaction facilitator to issue electronic instructions to transfer funds between two parties such as a customer and a merchant, person to person, business to person, business to business, etc.

It is an object of the invention to provide a payer or payee activated system for the electronic transfer of funds.

It is an object of the invention to interface with stored value cards or other stored value accounts, system, or device.

It is an object of the invention to promote discounts, and other benefits by merchants to customers by the use of the payment facilitator's system.

It is an object of the invention to prevent data breaches on the payer or payee's computer systems.

It is an object of the invention to promote finance options between the payer and payee.

It is an object of the invention to interface the system with ATMs or other cash withdrawal systems.

It is an object of the invention to electronically notify the payer of transactions so the account can be monitored.

Other objects, advantages and novel features of the present invention will become apparent from the following description of the preferred embodiments when considered in conjunction with the accompanying drawings.

### BRIEF DESCRIPTION OF THE DRAWINGS

FIG. 1 is a flow chart showing the payment facilitator system in use for a typical merchant and customer transaction.

FIG. 2 is a flow chart for the payment facilitator system in use for showing an international transfer of money from one member to another.

### DESCRIPTION OF THE PREFERRED EMBODIMENTS

A method of payment for P to P (Peer to Peer or Person to Person), P to B (Person to Business), B to P (Business to Person), B to B (Business to Business), G to P (Government to Person), P to G (Person to Government) or G to B (Government to Business) is provided. The method is designed to be a real-time payment network between members of a payment facilitator.

A transaction facilitator computer is used to set up memberships by collecting membership identity information and member's financial account information and storing the information in a computer database. The transaction facilitator then establishes connections between payer's and payee's financial institutions such as banks, credit unions, or brokerage firm accounts or accounts held by other organizations. The system can also be used with money storage cards such as gift certificates or other stored value cards.

Assuming for the purpose of illustration that the payer is an individual the individual would open his membership with the transaction facilitator by presenting himself at a data entry port such as at a bank or at a retail facility such as a Walmart®, or Target®, or a grocery store customer service center, and open the membership by having a photo taken and or a thumb print, finger print, voice scan, retina scan or other easy to identify bio-identifier unique to the member. The bio-identifier has to be easy to obtain to initiate a transaction. The new member will identify a bank or other financial institution on which he may withdraw funds. Similarly the payee must be a member and have presented his financial institution information. The new member may then be given an account number or other means to identify him as a member of the payment facilitator.

When the member payer presents himself to a payee who is also a member of the payment facilitator he may present his membership identification information and/or present himself for other bio-identifier methods such that he is identified as the member requesting a payment to be made. Such bio-identifiers may be photographs, thumb prints, iris scans, voice prints, or other bio-identifiers, or a form of government issued identification. At a merchant's point of sale terminal the payer member's photo may be displayed confirming the member's identity corresponding to the bio-identifying information and the transaction can be completed by the payment facilitator computer contacting the bank or other financial institution computer to see if funds are available for transfer. If the funds are available the transaction is completed by the funds being transferred immediately from the payer account to the payee account. The payee will then have the money in its account and the payer will have the goods or services paid for and get a receipt from the merchant payee that the transaction was completed. In this manner the payee is paid on the spot as if cash were presented. If there are insufficient funds, a message so stating is returned to payer or both payer and payee and the transaction is terminated or the payer may have the option of selecting another payer account to complete the transaction. A transaction fee is paid by the merchant (payee) to the payment facilitator for connecting the payer's bank account to the payee's bank account and facilitating the transfer of funds and for providing the information for positively identifying the payer as the account holder making the payment.

The payer or payee is a member, or a non member who uses a designated member agent, of the payment facilitator. A non member has an incentive to become a member in order to experience the incentives offered by using the system as well as to simplify his life by having one central source for all his financial transactions. He may use his membership in the transaction facilitator to manage all financial transactions such as direct deposit of pay or government transfer payments, and other income, and one point to manage all outgoing fund transactions instead of having multiple credit and debit cards, checks, ATM cards or cash to keep track of Merchants have the advantage of being able to draw member traffic to their place of business for signing up as a member and for purchases using the payment facilitator, greatly increasing the effectiveness of merchant advertising, and profits, as they will have many more customers in their stores.

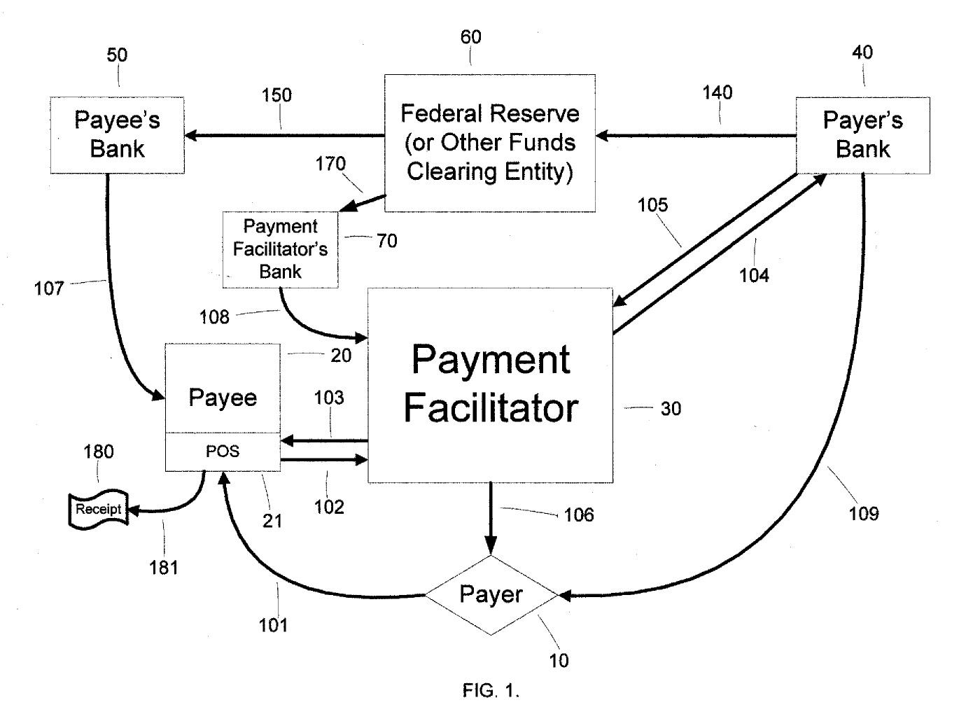

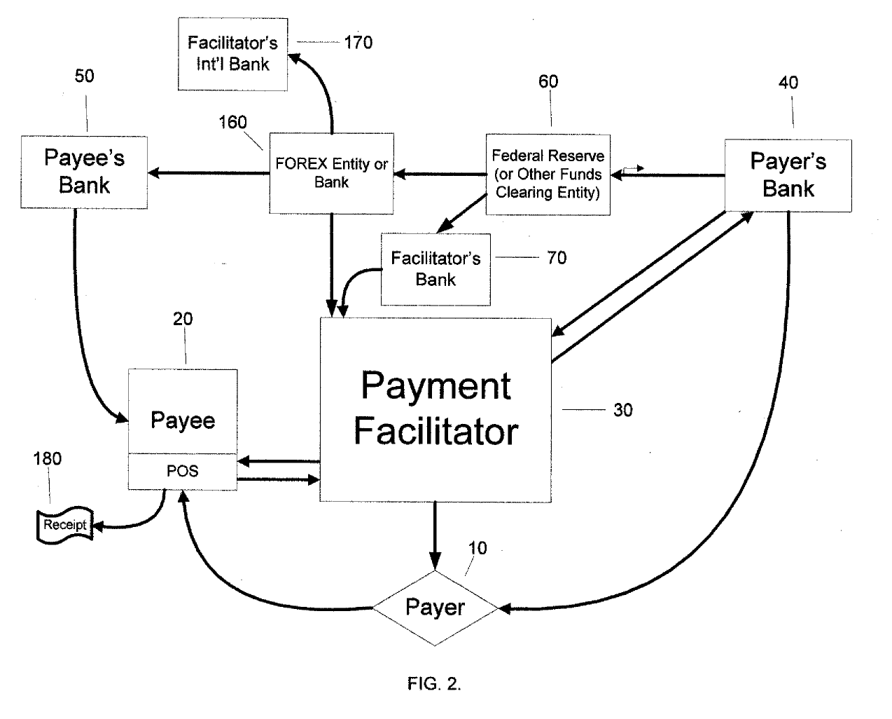

Referring to FIG. 1, a customer or buyer (payer) 10 at a merchant or seller's store (payee) 20 will have selected goods and wishes to pay for them. Assuming that both the seller 20 and the buyer 10 are members of the payment facilitator 30, the buyer 10 in step 101 presents his membership information to the seller 20. The buyer's information is transmitted in communications link 102 to the payment facilitator 30 such as through the seller's point of sale system 21 or alternatively by any other means of communication such as by the buyer 10 directly to the payment facilitator 30 by cell phone. To identify the buyer 10, a picture of the buyer or other bio-identifier information may be transmitted from the payment facilitator 30 to the seller 20 through communications link 103. Alternatively, the buyer 10 may be asked questions or to identify pictures by the payment facilitator 30 to establish his identity. If the buyer's 10 identity cannot be successfully confirmed or it is suspected that it is fraudulent, or mistaken information was entered the transaction may be cancelled. Further, the transaction, once initiated may be cancelled at any time by either party for any reason before the transaction it is finalized. If the identity of the buyer 10 is confirmed the payment facilitator 30 then contacts 104 the buy's 10 bank 40 to see if the buyer 10 has funds available for transfer to the seller 20. If the bank 40 responds yes the payment facilitator 30 sends a notice 105 the seller 20 that the funds are available for transfer and it is OK to release the merchandise to the buyer 10. If there is not enough money in the account to complete the transaction the buyer's bank 40 will so notify the payment facilitator 30 through communications link 105, and seller 20 (and possibly the buyer) will be so notified by the payment facilitator 30 through communications links 103 and the goods will not be released from the store 20. If there is a product return the merchant 20 may return the purchase price by using the payment facilitator 30 to return the money to the customer 10 as shown in FIG. 2.

Assuming the funds are available for transfer, the buyer's bank will so notify the payment facilitator 30 through communications link 105 and the payment facilitator 30 will initiate instructions through communications link 104 to transfer funds from the customer's bank 40 to the seller's bank 50, and also issue an instruction for the buyer's bank 40 to deduct a transaction fee from the money to be transferred from the buyer's account and pay it to the payment facilitator bank 70 for the payment facilitators account. Alternatively the transaction fee can be paid by payer 40 to the transfer facilitator 30.The actual money transfer may be by funds transfer 140 to the Federal Reserve Bank or an Automated Clearing House 60 and then through funds transfer 150 to the seller's bank 50 and also through funds transfer 170 to the payment facilitator's bank 70. Although a direct bank to bank through the Federal Reserve System or an Automated Clearning house transfer of funds is shown any electronic funds transfer method may be used, for example the funds may flow from the payer's bank to the payment facilitator's bank and then to the seller's bank. It may be that the payer and payee are both at the same bank.

The seller's bank 50 may have a communications link 107 to the seller 20 indicating that the transaction was completed. Further the payment facilitator's bank 70 may have a communications link 108 to the payment facilitator 30 to indicate it was paid and what it's balances are. Similarly the payer's bank 40 may have a communications link 109 with the buyer indicting that the transaction was completed and showing what the bank balances are.

When the seller 20 receives notice from the payment facilitator 39 or the sellers bank 50 that the money has been transferred the seller's point of sale system 21 can print out a sales receipt showing that the purchase was made.

The customer 10 may initiate the transaction by instructing the merchant 20 to use his payment facilitator 30 account. This may be done automatically by facial recognition, thumb print recognition or other bio-identifiers, or by presenting a card containing membership information or having a cell phone, PDA or other electronic account information transfer methods.

The payment facilitator 30 may be used for person to person payments when both the payer and payee, or member agents of either, have accounts at the payment facilitator.

Similarly, for online internet purchases as if the payer 10 is online making purchases through the use of a computer or other electronic communications device (whether a mobile device or not), or making a payment on behalf of a commercial, governmental or other type of entity, the buyer 10 selects the desired products or services online and checks out, or adds items to an online shopping cart and then checks out. When it comes time to pay (or donate in the case of a non-profit), the payer 10 would be asked what method of payment he wants to use. He would then select the desired payment facilitator 30 as the method of payment instead of a credit card or a PayPal® account. Then, the payer 10, would go through a multi-layered security path to ensure his identity with the payment facilitator 30, such as answering questions or identifying images, thus enabling him to complete a secure and confidential transaction. When the payment method of the payment facilitator 30 is selected, and all security measures passed, the instructions will then be confirmed by the payer 10 and the payment instructions will be initiated by the payment facilitator 30 to move funds from payer's account at payer's bank 40, to the payee's account at the payee's bank 50, through the same procedure as previously described for an in-person transaction as shown in FIG. 1.

Similarly the payment facilitator 30 can be used to refund money from the seller 20 (the payer in this example) to a buyer 10 (the payee in this example). As can be readily understood the system as shown in FIG. 1 now works backwards. The buyer 10 may be returning goods for a refund and has come to the seller's 20 store. The seller 20 will use his point of sale system 21 to contact the payment facilitator 30 and make a request to transfer money from the seller's account at bank 50 to the buyer's account at bank 40. The process for making the refund requires the seller to send a request by use of his point of sale system 21 or other communications method, to the payment facilitator 30 providing the payment facilitator with the seller's membership identification and directing the payment facilitator 30 to pay the buyer 10 and providing the buyer's membership information. The payment facilitator 30 having the seller's membership information sends a message to the seller's bank 50 directing it to pay the buyer 10 by transferring funds to the buyer's bank account in buyer's bank 40. The seller's bank 50 verifies the funds are in the seller's account and sends a confirmation message to the payment facilitator 30 that the funds are available and are being transferred as directed. The seller's bank 50 then electronically transfers the money to the buyer's bank 40 either directly to the buyer's bank 40 or through the Federal Reserve system or an a automated clearing house such as The Clearing House® 60. Alternatively the seller's bank 50 can transfer the money to the payment facilitator 30 at it's bank 70 for forwarding to the seller's buy's bank 50 to be deposited in the buyer's 10 bank account. Other electronic transfer methods may also be used to transfer funds between banks and bank accounts.

When the buyer's bank 40 receives the money transferred to the buyer's account it can send a message to the buyer 10 that the money has arrived or just provide the information in the next bank statement. The seller's bank 50 would also be instructed by the payment facilitator 30 the pay a transaction fee to the payment facilitator at it's bank 70.

The seller 20 when notified by the payment facilitator 30 that the money has been transferred, can then print a receipt 180 of sale with information 181 flowing from the from the point system 21 and present it to the buyer 10.

The general case of payers and payees from person to person, person to business, business to person, business to business, person to government, government to person, business to government or generally any party to any party can use the payment facilitator system to electronically transfer money by the method shown above. Any data input methods may be used in place of a point of sale system.

As shown in FIG. 2 the payment facilitator can be used for electronic transfer of funds for international transactions where foreign exchanges of currencies are used. Essentially the system is the same as described above wherein a payer can pay a payee in another country. The payer 10 contacts the payee 20 and presents his membership account information as before. Optionally the payer 10 can contact the payment facilitator 30 directly and ask for a transfer of funds to take place. The payment facilitator 30 then sends instructions to the payer's bank 40 to transfer money to the payee at his account in the payee's bank 60 and receives confirmation from the payer's bank that the transaction is taking place or has been denied. The confirmation or denial may be transmitted from the payment facilitator 30 to the payer 10 and the payee 20. The payer's bank transmits funds electronically through the Federal Reserve Bank an Automated Clearing House or by other means to a Forex bank 160 to convert the currency and to take it's fee and send the balance to the payee's bank 50. The payee's bank 50 may then notify the payee that the funds have been received. The payment facilitator may also notify the payee the funds were transferred. The transaction fee instructions include instructions to the payer's bank 40 to pay the payment facilitator. Similarly the Forex bank may also pay the facilitator's 30 foreign bank a fee. The payee 20 may sent the payer 10 a receipt indication payment was received.

The advantages for merchants to use the payment facilitator are that no interchange fees are paid, just a small transaction fee, and payment is received before the merchandise leaves the store just as in a cash payment. This may significantly increase the profitability of merchant 20.

By signing up for the payment facilitator accounts at the merchant's place of business or at the customer's bank, customer traffic is driven to the stores or banks and both store traffic and profits may increase by use of the payment facilitator.

Currency exchange rates can be applied if the member banks are in different countries. Other money transfer instructions may be used as customer or merchant demands require. Stored money cards or other account types may be used instead of bank accounts.

Funds transfers from person to person or sales of goods over the internet may use the payment facilitator and these can be domestic or international transactions

Person to person, person to bank, person to business, business to business, business to person, government to person, person to government, business to government or any other type of transactions can be transacted through the payment facilitator. In the case of organizations such as banks, businesses or governments, persons may be appointed as agents to be members of the payment facilitator system and be authorized to initiate transactions on behalf of such payers.

The payment facilitator may also be instructed to make automatic payments of specified amounts on specified dates or to pay things such as utility bills, mortgages, loans etc, or finance programs established between payer and payee, on specified dates.

The system can be either a “closed-loop” system, whereby both payer and payee are members of the system, or an “open-loop” system whereby one or the other is not a member and a third party acts as an agent for the non-member party (such as in international payments or funds transfers to others). The agent third party would be a payment facilitator member.

The payer member may be electronically notified by the payment facilitator of each use of his account by e-mail or other means so that he can monitor the account and have a record of the transaction history, as well as being immediately notified of any potential misuse of the account.

Obviously, many modifications and variations of the present invention are possible in light of the above teachings. It is therefore to be understood that, within the scope of the appended claims, the invention may be practiced otherwise than as specifically described.

What is claimed is:

1. A method for electronic transfer of money comprising, a payer becoming a member of a payment facilitator to provide identity information and account information to the payment facilitator and obtain payment facilitator membership identity information, storing the member identity information in a computer database,
a payee becoming a member of a payment facilitator to provide identity information and account information to the payment facilitator, and obtain a payment facilitator membership identity information, storing the member identity information in a computer database,
contacting a payment facilitator through a communications system,
directing the payment facilitator to instruct for the transfer of funds, from the payer's account to the payee's account,
the payment facilitator checking to see if the payee has funds available for the transfer, approving or rejecting the transaction and notifying the payee if the transaction was approved or rejected.
the payment facilitator charging a fee to the payee or the payer for the transaction payable to the payment facilitator's account.

2. A method for electronic transfer of money as in claim 1 and providing an identity confirmation method for the payee to identify the payer,

3. A method for electronic transfer of money as in claim 1 wherein, the transfer of funds between the payer and the payee accounts is directed through the federal reserve bank

4. A method for electronic transfer of money as in claim 1 wherein, the transfer of funds between the payer and the payee accounts is directed through an automated clearing house

5. A method for electronic transfer of money as in claim 1 wherein the transfer of funds between the payer and the payee accounts is directed from one account directly to another account.

6. A method for electronic transfer of money as in claim 1 wherein the transfer of funds between the payer and the payee accounts is directed from payer's account to the payment facilitator which transfers the funds to the payee's account.

7. A method for electronic transfer of money as in claim 2 wherein, the transfer of funds between the payer and the payee accounts is directed through the federal reserve bank

8. A method for electronic transfer of money as in claim 2 wherein, the transfer of funds between the payer and the payee accounts is directed through an automated clearing house

9. A method for electronic transfer of money as in claim 2 wherein the transfer of funds between the payer and the payee accounts is directed from one account directly to another account.

10. A method for electronic transfer of money as in claim 2 wherein the transfer of funds between the payer and the payee accounts is directed from payer's account to the payment facilitator which transfers the funds to the payee's account.

11. A method for electronic transfer of money as in claim 1 wherein the communications system is the payee's point of sale system

12. A method for electronic transfer of money as in claim 2 wherein the communications system is the payee's point of sale system.

13. A method for electronic transfer of money as in claim 1 wherein the communications system is the payor's cell phone.

14. A method for electronic transfer of money as in claim 2 wherein the communications system is the payor's cell phone.

15. A method for electronic transfer of money as in claim 1 wherein the transfer of funds between the payer and the payee accounts is directed through the payment facilitator.

16. A method for electronic transfer of money as in claim 1 wherein the transfer of funds between the payer and the payee accounts is directed from payer's account by the payment facilitator to the payee's account, which transfers the funds to the payee's account.

17. A method for electronic transfer of money as in claim 1 wherein the transfer of funds between the payer and the payee accounts is directed through another third-party entity.

18. A method for electronic transfer of money as in claim 1 wherein the communications system is the payor's biometric device.

19. A method for electronic transfer of money as in claim 1 wherein the communications system is the payor's biometric device.

20. A method for electronic transfer of money as in claim 2 wherein the transfer of funds between the payer and the payee accounts is directed through another third-party entity.
